(19) United States
(12) Patent Application Publication
(10) Pub. No.: US 2026/0208026 A1
(43) Pub. Date: Jul. 23, 2026

(54) APPROACHES TO GENERATING PROGRAMMATIC DEFINITIONS OF PHYSICAL ACTIVITIES THROUGH AUTOMATED ANALYSIS OF VIDEOS

(71) Applicant: Hinge Health, Inc., San Francisco, CA (US)

(72) Inventors: Angela Yeung, Cupertino, CA (US); Robert Lacroix, Saint-Lambert (CA)

(21) Appl. No.: 19/572,510

(22) Filed: Mar. 19, 2026

Related U.S. Application Data
(63) Continuation of application No. PCT/US2024/050132, filed on Oct. 4, 2024.
(60) Provisional application No. 63/588,663, filed on Oct. 6, 2023.

(51) Int. Cl. A63B 71/06; G06V 20/40

(52) U.S. Cl. CPC A63B 71/0622; A63B 71/0669; G06V 20/42

(57) ABSTRACT

Introduced here are approaches to generating programmatic definitions of activities that are performed in videos and are to be mimicked by users of a pose monitoring platform. While these approaches can be implemented by the pose monitoring platform, the videos could be obtained from another source (e.g., an online video sharing platform or a social media platform). These approaches help solve the problem of limited exercise therapy being available, allowing programmatic definitions to be readily created for new physical activities and improving adherence to exercise therapy programs that require consistent performance of physical activities.

### CROSS-REFERENCE TO RELATED APPLICATIONS

This application is a continuation of International Application No. PCT/US24/50132, titled “Approaches To Generating Programmatic Definitions Of Physical Activities Through Automated Analysis Of Videos” and filed Oct. 4, 2024, which claims priority to U.S. Provisional Application No. 63/588,663, titled “Approaches to Generating a Programmatic Definition of an Exercise” and filed on Oct. 6, 2023, each of which is incorporated by reference herein in its entirety.

### TECHNICAL FIELD

Various embodiments concern computer programs and associated computer-implemented techniques for determining poses of a living body for physical activities and estimating poses of the living body while performing the physical activity.

### BACKGROUND

Exercise therapy is an intervention technique that utilizes physical activity as the principal treatment method for addressing the symptoms of musculoskeletal (“MSK”) conditions, such as acute physical ailments and chronic physical ailments. Exercise therapy programs may involve a plan for performing physical activities during exercise therapy sessions that occur on a periodic basis. Generally, the purpose of an exercise therapy program is to either restore normal MSK function or reduce the pain caused by an acute or chronic physical ailment, which may have been caused by injury or disease. As such, the physical activities to be performed in each exercise therapy session may be selected in order to achieve a specific therapeutic goal. Examples of therapeutic goals include lessening pain, improving flexibility, rehabilitating injuries, managing diseases, and the like.

These exercise therapy programs normally depict how a user should perform one or more physical activities to achieve a specific therapeutic goal within a time period. However, these exercise pose monitoring platforms currently are limited to videos made by physical therapists. Therefore, these exercise pose monitoring platforms usually are unable to monitor whether the user is properly performing physical activities based on third-party videos. For example, if the user is not using the proper technique to perform a physical activity from a third-party video, she may not experience improvement in her acute or chronic pain, flexibility, or the like, causing the user to become discouraged from doing her exercise therapy sessions. Therefore, a better approach is needed for monitoring pose to ensure that users are able to achieve lasting improvement in terms of MSK function using a variety of videos. The benefits of improved performance of poses are not limited to exercise therapy programs.

Pose estimation (also called “pose detection”) is an active area of study in the field of computer vision. Over the last several years, tens—if not hundreds—of different approaches have been proposed in an effort to solve the problem of pose detection. Many of these approaches rely on machine learning due to its programmatic approach to learning what constitutes a pose.

As a field of artificial intelligence, computer vision enables machines to perform image-processing tasks with the aim of imitating human vision. Pose estimation is an example of a computer vision task that generally includes detecting, associating, and tracking the movements of a person. This is commonly done by identifying “key points” that are semantically important to understanding pose. Examples of key points include “head,” “left shoulder,” “right shoulder,” “left knee,” and “right knee.” Insights into posture and movement can be drawn from an analysis of these key points.

### BRIEF DESCRIPTION OF THE DRAWINGS

FIG. 1 illustrates an example of displaying an evaluation metric for the performance of a generated programmatic definition of an activity.

FIG. 2 illustrates a network environment that includes a pose monitoring platform that is executed by a computing device.

FIG. 3 illustrates an example of a computing device that is able to execute a pose monitoring platform.

FIG. 4 illustrates an analysis module of a pose monitoring platform.

FIG. 5A depicts an example of a communication environment that includes a pose monitoring platform configured to receive several types of data.

FIG. 5B depicts another example of a communication environment that includes a pose monitoring platform configured to obtain data from one or more sources.

FIG. 6 includes a flow of red-green-blue (“RGB”) digital images that illustrate how the pose monitoring platform can estimate the raw pose and then forward align the raw poses.

FIGS. 7A-7D depict a flow diagram and ecosystem for generating a programmatic definition.

FIG. 8 is a block diagram illustrating an example of a processing system in which at least some operations described herein can be implemented.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Over the last several years, significant advances have been made in the field of computer vision. This has resulted in the development of sophisticated pose estimation programs (also called “pose estimators” or “pose predictors”) that are designed to perform pose estimation in either two dimensions or three dimensions. Two-dimensional (“2D”) pose estimators predict the 2D spatial locations of key points, generally through the analysis of the pixels of a single digital image. Three-dimensional (“3D”) pose estimators predict the 3D spatial arrangement of key points, generally through the analysis of the pixels of multiple digital images—for example, consecutive frames in a video—or a single digital image in combination with another type of data generated by, for example, an inertial measurement unit (“IMU”) or Light Detection and Ranging (“LiDAR”) unit.

Pose estimators—both 2D and 3D—continue to be applied to different contexts and, as such, continue to be used to help solve different problems. One problem for which pose estimators have proven to be particularly useful is creating and monitoring the performance of physical activities. Consider, for example, a scenario where an individual is instructed or prompted to perform a physical activity by a computer program. By applying a pose estimator to digital images of an individual teaching the physical activity, the computer program can determine the proper poses the individual performing the physical activity should be executing. Aside from that, by tracking the poses of the individual performing the physical activity, the computer program can glean insight into the performance of the physical activity. Historically, the individual may have instead been asked to summarize her performance of the physical activity (e.g., in terms of difficulty); however, this type of manual feedback tends to be inaccurate and inconsistent. Due to their consistent, programmatic nature, pose estimators allow for more accurate monitoring of performances of physical activities.

This is especially important if the pose estimator is responsible for monitoring physical activities that have meaningful real-world impact, such as on the health and wellness of the individual responsible for performing the physical activities. Exercise therapy is an intervention technique that utilizes physical activities as the principal treatment for addressing the symptoms of musculoskeletal (“MSK”) conditions, such as acute physical ailments and chronic physical ailments. Exercise therapy programs (or simply “programs”) generally involve a plan for performing physical activities during exercise therapy sessions (or simply “sessions”) that occur on a periodic basis. Normally, the purpose of a program is to either restore normal MSK functionality or reduce the pain caused by a physical ailment, which may have been caused by injury or disease.

As part of the exercise therapy program, a user may be requested to engage with a computer-implemented platform (also referred to as a “pose monitoring platform”) that is accessible via a computer program executing on a computing device. The term “user” may be used to generally refer to an individual who engages in physical activities via the pose monitoring platform. Over time, the user may be instructed to perform physical activities during physical activity sessions (or simply “sessions”) as part of a program. For example, the user may be instructed to perform a series of physical activities over the course of a session, and the user may be prompted to complete a series of sessions over the course of several days, weeks, or months. The pose monitoring platform may not only assist the user by actively guiding her through each session but also help her achieve and maintain proper technique in performing the physical activities.

However, one issue is that individuals (also called “users,” “patients,” or “participants”) struggle to stay consistently engaged with their exercise therapy programs. One approach to improving or maintaining engagement involves allowing users to select third-party videos to use for their exercise therapy programs. Consider, for example, a scenario in which a user would like to mirror the movements of a favorite yoga instructor or dance instructor, as exhibited in a video available on an online video sharing platform or a social media platform. The primary issue is that these videos available from online video sharing platforms and social media platforms lack pose estimators. Said another way, these videos are not associated with programmatic definitions of the movements performed therein, making it difficult, if not impossible, to establish whether the user is accurately mirroring the movements shown in the video.

Introduced here are approaches to generating programmatic definitions of physical activities that are performed in videos and are to be mimicked by users. Note that the term “physical activities” could be used interchangeably with the term “exercises,” as the users may mimic performances of physical activities for exercise purposes as required by an exercise therapy program. These approaches can be implemented by a pose monitoring platform (or simply “platform”), as further discussed below. However, the videos are generally not available directly from the pose monitoring platform but instead may be available from an online video sharing platform (e.g., the YouTube® video sharing platform) or a social media platform (e.g., the Facebook® platform, Instagram® platform, X™ platform, TikTok® platform) and therefore may be called “third-party videos.”

These approaches help solve the problem of limited exercise therapy being available. This also allows the pose monitoring platform to save time, financial expenses, and computational expenses since healthcare professionals (e.g., physiotherapists, nurses, or physicians) do not need to manually monitor exercises performed by users, nor do videos of users performing exercises need to be transmitted to healthcare professionals for review. Instead, a healthcare professional may simply be able to identify improper skeletal positions based on a comparison of the user's movements to a programmatic definition for an exercise that she intends to mirror—or the pose monitoring platform may establish whether the user is properly mirroring the exercise on its own. Accordingly, the approaches may allow users to perform high-quality exercise therapy using videos of their choosing. Aside from that, the approaches may also permit the pose monitoring platform to generate a repository of programmatic definitions for exercises performed in different videos, and each programmatic definition can serve as a reference for the pose monitoring platform—and more specifically, its pose estimator—in determining whether the corresponding exercise is being performed properly.

As further discussed below, the approaches may rely on real-time analysis of poses that are estimated for an individual as she performs a physical activity. These estimated poses—or indicia that are visually representative thereof—may be presented for display on an interface that is accessible to a computing device. Generally, the computing device is associated with the individual and is responsible for generating the digital images from which the poses are estimated.

Accordingly, a pose monitoring platform may be able to:
Define a programmatic definition for a physical activity based on an analysis of a video that includes a performance of the physical activity by a first individual and, more specifically, by defining a series of skeletal positions that are arranged in temporal order;
Produce a series of representations by establishing the skeletal position of a second individual on a periodic basis (e.g., every frame, every third frame, every fifth frame, or every tenth frame of a video), as the second individual performs the physical activity in an attempt to mimic the performance of the physical activity by the first individual;
Compare the series of representations produced for the second individual to the programmatic definition that is based on the performance of the physical activity by the first individual; and
Present feedback regarding the performance of the physical activity in a way that is helpful for the second individual.
   Note that the pose monitoring platform could also extract one or more features of a first individual who is demonstrating, through her performance of a physical activity, a proper position or an improper position in a video. Thus, the first individual may not only be able to demonstrate proper performances of activities—which is more likely the case if the video is obtained from, or accessed on, an online video sharing platform or social media platform—but may also be able to demonstrate improper performances of activities. For example, a healthcare professional could record several videos: one or more videos demonstrating proper form while performing a physical activity and one or more videos demonstrating improper form while performing the physical activity.

The nature of the representations of the second individual may depend on the nature of the pose extractor that is applied by the pose monitoring platform to produce the series of representations. For example, if the pose extractor is a 2D pose extractor, the representations may be 2D skeletal frames that define the 2D spatial locations of key points. If the pose extractor is a 3D pose extractor, the representations may be 3D skeletal frames that define the 3D spatial locations of key points.

Although unique templates can be specified for each physical activity, one advantage of this method is that it may be general to a wide range of physical activities. As a result, programmatic definitions corresponding to various physical activities could be created and made available to the pose monitoring platform, but new programmatic definitions for existing physical activities or new programmatic definitions for new physical activities (e.g., new dances) could also be readily added. Existing programmatic definitions could also be removed or made unavailable to the pose monitoring platform.

For the purpose of illustration, embodiments may be described with reference to exercises that are performed during sessions as part of a program. However, the pose monitoring platform could be designed to monitor the performance of other physical activities, such as sporting activities, cooking activities, art activities, and the like. Accordingly, the approach described herein could be used to provide personalized feedback regarding the performance of nearly any physical activity.

Moreover, embodiments may be described in the context of computer-executable instructions for the purpose of illustration. However, aspects of the approach could be implemented via hardware or firmware instead of, or in addition to, software. As an example, the pose monitoring platform may be embodied as a computer program that offers support for completing exercises during sessions as part of a program, determines which physical activities are appropriate for a user given performance during past sessions, and enables communication between the user and one or more coaches. The term “coach” may be used to generally refer to individuals who prompt, encourage, or otherwise facilitate engagement by users with the pose monitoring platform. Coaches are generally not healthcare professionals but could be in some embodiments.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Overview of Pose Monitoring Platform

As discussed above, a pose monitoring platform may be responsible for guiding a user through sessions that are performed as part of a program. As part of the program, the user may be requested to engage with the pose monitoring platform on a periodic basis. The frequency with which the user is requested to engage with the pose monitoring platform may be based on factors such as the anatomical region for which therapy is needed, the MSK condition (or non-healthcare related condition, such as a desire to improve technique) for which therapy is needed, the difficulty of the program, the age of the user, the amount of progress that has been achieved, and the like.

The pose monitoring platform may perform three-dimensional (3D) pose estimation, where a pose comprises 3D locations in an image of joints in a body (e.g., elbows) and of body parts (e.g., face, hands, etc.). For accuracy, the pose monitoring platform performs pose estimation in a top-down manner by detecting body part instances in an image, cropping the body part instances out of the image, and processing the crops using a model. The model may be trained on images of body parts, so without a branch to determine whether an image includes a body part, the model may “hallucinate” by assuming that each image includes a body part and outputting an estimated pose even if the image does not contain a body part. To alleviate this hallucination effect, the model includes a first branch for predicting body part presence along with a second branch for estimating pose. The first branch provides an added layer of prediction to the model and outputs higher scores for an image that includes a body part than for an image that does not.

As mentioned above, the pose monitoring platform may estimate pose in contexts that are unrelated to healthcare—for example, to improve technique. For example, the pose monitoring platform may estimate the pose of an individual while she completes an athletic activity (e.g., dancing, shooting a basketball, throwing a baseball), a virtual reality activity, an augmented reality activity, a cooking activity, an art activity, etc. Accordingly, while embodiments may be described in the context of a “user,” the features of those embodiments may be similarly applicable to individuals performing physical activities. These individuals may also be referred to as “users” of the pose monitoring platform.

Even if the pose monitoring platform is able to request that a user engage at a given frequency, the user will normally have the autonomy to engage with the program as frequently as she desires. Thus, the user may define a schedule for completing sessions (e.g., every day, every other day, or twice per week) as further discussed below, and various features of the pose monitoring platform may be designed in support of this habit formation. Alternatively, the user may complete sessions on an ad hoc basis.

As the user performs exercises, she may be recorded by a camera of a computing device. Normally, the camera is part of the computing device on which the motion monitoring is executed or accessed. For example, in order to initiate a session, the user may initiate a mobile application that is stored on, and executable by, her mobile phone or tablet computer, and the mobile application may instruct the user to position her mobile phone or tablet computer in such a manner that one of its cameras can record her as exercises are performed. Note that, in some embodiments, the camera is part of another computing device. For example, the camera may be included in a peripheral computing device, such as a web camera (also called a “webcam”), that is connected to the computing device. By examining the digital images that are output by the camera, the motion monitoring platform can monitor the performance of the exercises by estimating the pose of the user over time.

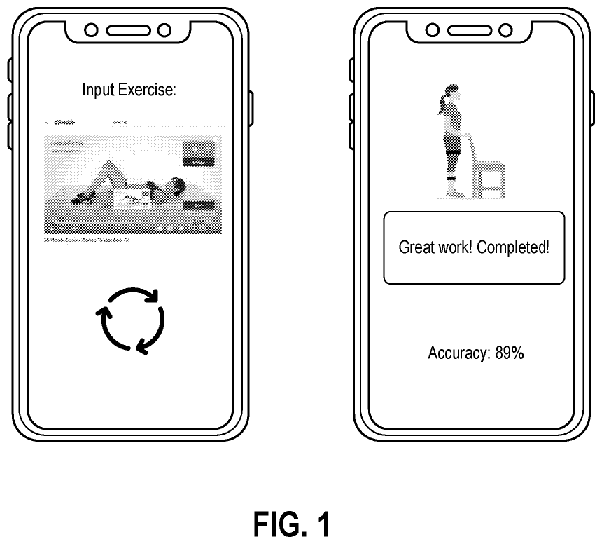

FIG. 1 illustrates examples of several interfaces. The leftmost interface shows how an individual may be permitted to identify a video that includes a performance of a physical activity by another person. The individual could upload the video itself, or the individual could identify the video in some other manner—for example, by inputting a Uniform Resource Locator (“URL”) that directs to the video. The rightmost interface shows how after the individual has completed her performance of the physical activity, mimicking the performance of the other person in the identified video, an evaluation metric could be presented. The evaluation metric could be determined based on the comparison of the user's pose over the course of her performance of the physical activity against the other person's pose over the course of her performance of the physical activity. As further discussed below, the pose monitoring platform can accomplish this by (i) generating a programmatic definition for the physical activity by applying a pose estimator to different frames of the video, thereby creating a first series of poses that serves as reference, (ii) applying the pose estimator to different frames of a live video feed of the individual performing the physical activity, thereby creating a second series of poses, and (iii) comparing the second series of poses to the first series of poses.

In some embodiments, the evaluation metric is based on a “raw” comparison of the second series of poses to the first series of poses. Thus, the evaluation metric could be indicative of the number of poses that are determined to match, how closely poses in the second series match corresponding poses in the first series, etc. In other embodiments, the evaluation metric is based on a “weighted” or “tuned” comparison of the second series of poses to the first series of poses. Consider, for example, a scenario in which the physical activity is a popular dance having one or more notable segments. In such a scenario, the notable segments may be weighted more heavily so that the evaluation metric is more representative of performance during the notable segments—which the user is most likely interested in mimicking.

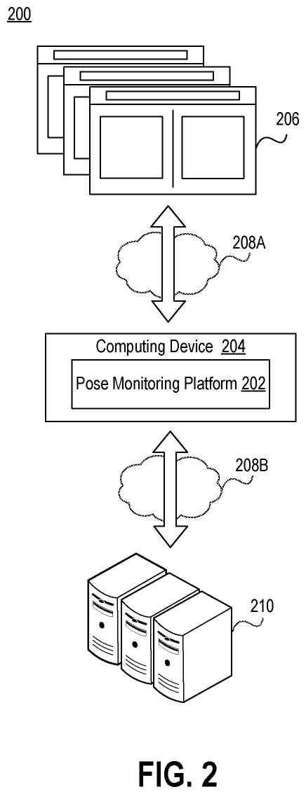

FIG. 2 illustrates a network environment 200 that includes a pose monitoring platform 202 that is executed by a computing device 204. Users can interact with the pose monitoring platform 202 via interfaces 206. For example, users may be able to access interfaces that are designed to guide them through physical activities, indicate progress, present feedback, etc. As another example, users may be able to access interfaces through which information regarding completed physical activities can be reviewed, feedback can be provided, etc. For instance, patients may be able to access interfaces that allow them to upload third-party videos, guide them through the activities in the user-selected videos, and view feedback from previous sessions and compare it to the current session. Coaches may be able to access interfaces that allow them to identify improper positions in an activity, provide real-time feedback to a patient, or recommend physical activities or exercises for the patient to encourage progress. Thus, interfaces 206 may serve as informative spaces, or the interfaces 206 may serve as collaborative spaces through which users and coaches can communicate with one another.

As shown in FIG. 2, the pose monitoring platform 202 may reside in a network environment 200. Thus, the computing device on which the pose monitoring platform 202 is executing may be connected to one or more networks 208A-B. Depending on its nature, the computing device 204 could be connected to a personal area network (“PAN”), local area network (“LAN”), wide area network (“WAN”), metropolitan area network (“MAN”), or cellular network. For example, if the computing device 204 is a mobile phone, then the computing device 204 may be connected to a computer server of a server system 210 via the Internet. As another example, if the computing device 204 is a computer server, then the computing device 204 may be accessible to users via respective computing devices that are connected to the Internet via LANs.

The interfaces 206 may be accessible via a web browser, desktop application, mobile application, or another form of computer program. For example, to interact with the pose monitoring platform 202, a user may initiate a web browser on the computing device 204 and then navigate to a web address associated with the pose monitoring platform 202. As another example, a user may access, via a desktop application or mobile application, interfaces that are generated by the pose monitoring platform 202 through which she can select physical activities to complete, review analyses of her performance of the physical activities, and the like. Accordingly, interfaces generated by the pose monitoring platform 202 may be accessible via various computing devices, including mobile phones, tablet computers, desktop computers, wearable electronic devices (e.g., watches or fitness accessories), virtual reality systems, augmented reality systems, and the like.

Generally, the pose monitoring platform 202 is hosted, at least partially, on the computing device 204 that is responsible for generating the digital images to be analyzed, as further discussed below. For example, the pose monitoring platform 202 may be embodied as a mobile application executing on a mobile phone or tablet computer. In such embodiments, the instructions that, when executed, implement the pose monitoring platform 202 may reside largely or entirely on the mobile phone or tablet computer. Note, however, that the mobile application may be able to access a server system 210 on which other aspects of the pose monitoring platform 202 are hosted.

In some embodiments, aspects of the pose monitoring platform 202 are executed by a cloud computing service operated by, for example, Amazon Web Services®, Google Cloud Platform™, or Microsoft Azure®. Accordingly, the computing device 204 may be representative of a computer server that is part of a server system 210. Often, the server system 210 is comprised of multiple computer servers. These computer servers can include information regarding different physical activities; computer-implemented models (or simply “models”) that indicate how anatomical regions should move when a given physical activity is performed; computer-implemented templates (or simply “templates”) that indicate how anatomical regions should be positioned when partially or fully engaged in a given physical activity; algorithms for processing image data from which spatial position of anatomical regions can be computed, inferred, or otherwise determined; user data such as name, age, weight, ailment, enrolled program, duration of enrollment, and number of physical activities completed; and other assets.

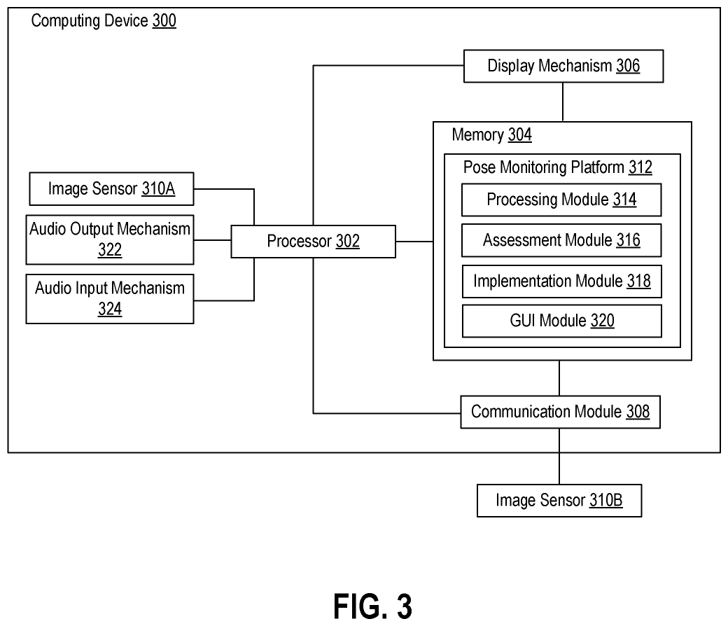

FIG. 3 illustrates an example of a computing device 300 that is able to execute a pose monitoring platform 312. As mentioned above, the pose monitoring platform 312 can facilitate the performance of physical activities by a user, for example, by providing instruction or encouragement. As shown in FIG. 3, the computing device 300 can include a processor 302, memory 304, display mechanism 306, communication module 308, image sensor 310A, audio output mechanism 322, and audio input mechanism 324. Each of these components is discussed in greater detail below.

Those skilled in the art will recognize that different combinations of these components may be present depending on the nature of the computing device 300. For example, if the computing device 300 is a computer server that is part of a server system (e.g., server system 210 of FIG. 2), then the computing device 300 may not include the display mechanism 306, image sensor 310A, audio output mechanism 322, or audio input mechanism 324, though the computing device 300 may be communicatively connectable to another computing device that does include a display mechanism, an image sensor, an audio output mechanism, or an audio input mechanism.

The processor 302 can have generic characteristics similar to general-purpose processors, or the processor 302 may be an application-specific integrated circuit (“ASIC”) that provides control functions to the computing device 300. As shown in FIG. 3, the processor 302 can be coupled to all components of the computing device 300, either directly or indirectly, for communication purposes.

The memory 304 may be comprised of any suitable type of storage medium, such as static random-access memory (“SRAM”), dynamic random-access memory (“DRAM”), electrically erasable programmable read-only memory (“EEPROM”), flash memory, or registers. In addition to storing instructions that can be executed by the processor 302, the memory 304 can also store data generated by the processor 302 (e.g., when executing the modules of the pose monitoring platform 312) and produced, retrieved, or obtained by the other components of the computing device 300. For example, data received by the communication module 308 from a source external to the computing device 300 (e.g., image sensor 310B) may be stored in the memory 304, or data produced by the image sensor 310A may be stored in the memory 304. Note that the memory 304 is merely an abstract representation of a storage environment. The memory 304 could be comprised of actual integrated circuits (also referred to as “chips”).

The display mechanism 306 can be any mechanism that is operable to visually convey information to a user. For example, the display mechanism 306 may be a panel that includes light-emitting diodes (“LEDs”), organic LEDs, liquid crystal elements, or electrophoretic elements. In some embodiments, the display mechanism 306 is touch sensitive. Thus, a user may be able to provide input to the pose monitoring platform 312 by interacting with the display mechanism 306. Alternatively, the user may be able to provide input to the pose monitoring platform 312 through some other control mechanism.

The communication module 308 may be responsible for managing communications external to the computing device 300. For example, the communication module 308 may be responsible for managing communications with other computing devices (e.g., server system 210 of FIG. 2 or a camera peripheral such as a video camera or webcam). The communication module 308 may be wireless communication circuitry that is designed to establish communication channels with other computing devices. Examples of wireless communication circuitry include 2.4 gigahertz (“GHz”) and 5 GHz chipsets compatible with Institute of Electrical and Electronics Engineers (“IEEE”) 802.11—also referred to as “Wi-Fi chipsets.” Alternatively, the communication module 308 may be representative of a chipset configured for Bluetooth®, Near Field Communication (“NFC”), and the like. Some computing devices—like mobile phones and tablet computers—are able to wirelessly communicate via separate channels. Accordingly, the communication module 308 may be one of the multiple communication modules implemented in the computing device 300. As an example, the communication module 308 may initiate and then maintain one communication channel with a camera peripheral (e.g., via Bluetooth), and the communication module 308 may initiate and then maintain another communication channel with a server system (e.g., via the Internet).

The nature, number, and type of communication channels established by the computing device 300—and more specifically, the communication module 308—may depend on the sources from which data is received by the pose monitoring platform 312 and the destinations to which data is transmitted by the pose monitoring platform 312. Assume, for example, that the computing device 300 is representative of a mobile phone or tablet computer that is associated with (e.g., owned by) a user. In some embodiments, the communication module 308 may only externally communicate with a computer server, while in other embodiments, the communication module 308 may also externally communicate with a source from which to receive image data. The source could be another computing device (e.g., a mobile phone or camera peripheral that includes an image sensor 310B) to which the mobile device is communicatively connected. Image data could be received from the source even if the mobile phone generates its own image data. Thus, image data could be acquired from multiple sources, and these image data may correspond to different perspectives of the user performing a physical activity. Regardless of the number of sources, image data—or analyses of the image data—may be transmitted to the computer server for storage in a digital profile that is associated with the user. The same may be true if the pose monitoring platform 312 acquires only image data generated by the image sensor 310A. The image data may initially be analyzed by the pose monitoring platform 312, and then the image data—or analyses of the image data—may be transmitted to the computer server for storage in the digital profile.

The image sensor 310A may be any electronic sensor that is able to detect and convey information in order to generate images, generally in the form of image data (also called “pixel data”). Examples of image sensors include charge-coupled device (“CCD”) sensors and complementary metal-oxide semiconductor (“CMOS”) sensors. The image sensor 310A may be part of a camera module (or simply “camera”) that is implemented in the computing device 300. In some embodiments, the image sensor 310A is one of the multiple image sensors implemented in the computing device 300. For example, the image sensor 310A could be included in a front-or rear-facing camera on a mobile phone. Alternatively, the image sensor 310A may be externally connected to the computing device 300 such that the image sensor 310A captures image data of an environment and sends the image data to the pose monitoring platform 312.

For convenience, the pose monitoring platform 312 may be referred to as a computer program that resides in the memory 304. However, the pose monitoring platform 312 could be comprised of hardware or firmware in addition to, or instead of, software. In accordance with embodiments described herein, the pose monitoring platform 312 may include a processing module 314, assessment module 316, implementation module 318, and graphical user interface (“GUI”) module 320. These modules can be an integral part of the pose monitoring platform 312. Alternatively, these modules can be logically separate from the pose monitoring platform 312 but operate “alongside” it. Together, these modules may enable the pose monitoring platform 312 to programmatically monitor the motion of users during the performance of physical activities, such as exercises, through analysis of digital images generated by the image sensor 310.

The processing module 314 can process image data obtained from the image sensor 310A over the course of a session. The image data may be used to infer a spatial position or orientation of one or more anatomical regions, as further discussed below. The image data may be a representation of a series of digital images. These digital images may be discretely captured by the image sensor 310A over time, such that each digital image captures the user at different stages of performing a physical activity. In some embodiments, these digital images may be representative of frames of a video that is captured by the image sensor 310. In such embodiments, the image data could also be called “video data.”

The image data may be used to infer a spatial position of one or more anatomical regions, as further discussed below. For example, the processing module 314 may perform operations (e.g., filtering noise, changing contrast, reducing size) to ensure that the data can be handled by the other modules of the pose monitoring platform 312. As another example, the processing module 314 may temporally align the data with data obtained from another source (e.g., another image sensor) if multiple data are to be used to establish the spatial position of the anatomical regions of interest.

Moreover, the processing module 314 may be responsible for processing information input by users through interfaces generated by the GUI module 320. For example, the GUI module 320 may be configured to generate a series of interfaces that are presented in succession to a user as she completes physical activities as part of a session. On some or all of these interfaces, the user may be prompted to provide input. For example, the user may be requested to indicate (e.g., via a verbal command or tactile command provided via, for example, the display mechanism 306) that she is ready to proceed with the next physical activity, that she completed the last physical activity, that she would like to temporarily pause the session, etc. In another example, the user may be prompted to indicate or input a video from other platforms, such as the YouTube video sharing platform, to guide the user through a physical activity. These inputs can be examined by the processing module 314 before information indicative of these inputs is forwarded to another module.

The assessment module 316 (or simply “assessment module”) may be responsible for estimating the pose of the user through analysis of image data, in accordance with the approach further discussed below. Specifically, the assessment module 316 can create, based on a digital image (e.g., generated by the image sensor 310A or image sensor 310B), a series of skeletal positions that specifies a series of spatial positions of each major anatomical region. For example, the assessment module 316 can apply a computer-implemented model (or simply “model”) referred to as a pose estimator to the digital image so as to produce the skeletal position. The assessment module 316 can create improper skeletal positions based on specific digital images from an instructor. For example, an instructor can record themselves poorly performing a chosen physical activity. For instance, the instructor can record themselves bending their knees when performing jumping jacks. In some embodiments, the pose estimator is designed and trained to identify a predetermined number of joints (e.g., left and right wrist, left and right elbow, left and right shoulder, left and right hip, left and right knee, left and right ankle, or any combination thereof), while in other embodiments, the pose estimator is designed and trained to identify all joints that are visible in the digital image provided as input. The pose estimator could be a neural network that, when applied to the digital image, analyzes the pixels to independently identify digital features that are representative of each anatomical region of interest.

The implementation module 318 may be responsible for establishing a programmatic definition for the activity based on the outputs from the assessment module 316. The implementation module 318 can generate the programmatic definition using an improper skeletal position and a series of skeletal positions corresponding to a performance of the activity with proper form. In another embodiment, the programmatic definition includes a series of skeletal positions corresponding to a performance of the activity with proper form and at least a type identifier corresponding to a type of the exercise, a duration corresponding to an interval of time over which to perform the exercise, or a repetition count corresponding to a minimum number of repetitions to perform the exercise. For example, the implementation module 318 can apply detection algorithms to identify the type of exercise, the repetition count, and/or the intensity of the exercise to detect and monitor the user's performance of the exercise.

The implementation module 318 may be responsible for establishing the locations of the major anatomical regions of interest based on the outputs produced by the assessment module 316. Referring again to the aforementioned examples, the assessment module 316 could establish the locations of joints based on an analysis of both the proper and improper skeletal positions for a physical activity. For example, the implementation module 318 monitors the patient's performance in real time and applies a version of the pose estimator to the video received from the patient's device. Moreover, the implementation module 318 may be responsible for determining appropriate feedback for the user based on the outputs produced after applying a version of the pose estimator to the patient's performance, in accordance with the approach further discussed below. Specifically, the implementation module 318 may determine an appropriate personalized recommendation for the user based on her current position and a determination as to how her current position compares to the programmatic definition that is associated with the physical activity that she has been instructed to perform.

In one example, the implementation module 318 performs an automated analysis of the series of skeletal positions to determine personalized feedback to the patient. The automated analysis can be done by comparing the series of skeletal positions of the patient against a reference series of skeletal positions. The reference series of skeletal positions is received from the assessment module 316. The reference series can be obtained directly from the instructor or a video from a third party. After the automated analysis, the implementation module 318 can produce a percentage of accuracy to display on the user device by applying a machine learning model to calculate a similarity score. In another example, the computing device 300 can generate a point system. The patient can receive a point for every completed exercise and can receive multiple points for a high similarity score. The computing device 300 can display, to the patient, a number of points received after the activity is completed. In response to determining the patient can perform the activity with a higher similarity score, the computing device 300 can notify the patient of an opportunity to perform the activity a second time for double the number of points.

Other modules could also be included in some embodiments. For example, the pose monitoring platform 312 may include a training module (not shown) that is responsible for training the pose estimator that is employed by the pose assessment module 316.

Similarly, other components could be implemented in, or accessible to, the computing device 300 in some embodiments. For example, some embodiments of the computing device 300 include an audio output mechanism 322 and/or an audio input mechanism 324. The audio output mechanism 322 may be any apparatus that is able to convert electrical impulses into sound. One example of an audio output mechanism is a loudspeaker (or simply “speaker”). Meanwhile, the audio input mechanism 324 may be any apparatus that is able to convert sound into electrical impulses. One example of an audio input mechanism is a microphone. Together, the audio output and input mechanisms 322, 324 may enable feedback, such as a personalized recommendation as further discussed below, to be audibly provided to the user. Assume, for example, that the user has been instructed to perform a physical activity while being recorded by the image sensor 310A. In such a scenario, the user may be audibly encouraged—in a personalized manner—via the audio output mechanism 322. In one example, the patient may be audibly encouraged by an instructor via the audio output mechanism 322.

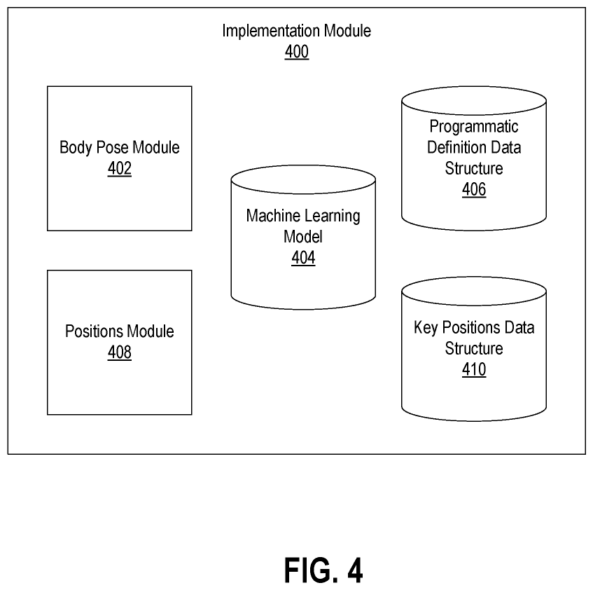

FIG. 4 illustrates an example of a computing device 300 that is able to implement a program in which a user is requested to perform physical activities, such as exercises, during sessions by a pose monitoring platform 312. In some embodiments, the pose monitoring platform 312 is embodied as a computer program that is executed by the computing device 300. In other embodiments, the pose monitoring platform 312 is embodied as a computer program that is executed by another computing device (e.g., a computer server) to which the computing device 300 is communicatively connected. In such embodiments, the computing device 300 may transmit data captured by the image sensor 310 to the other computing device for processing.

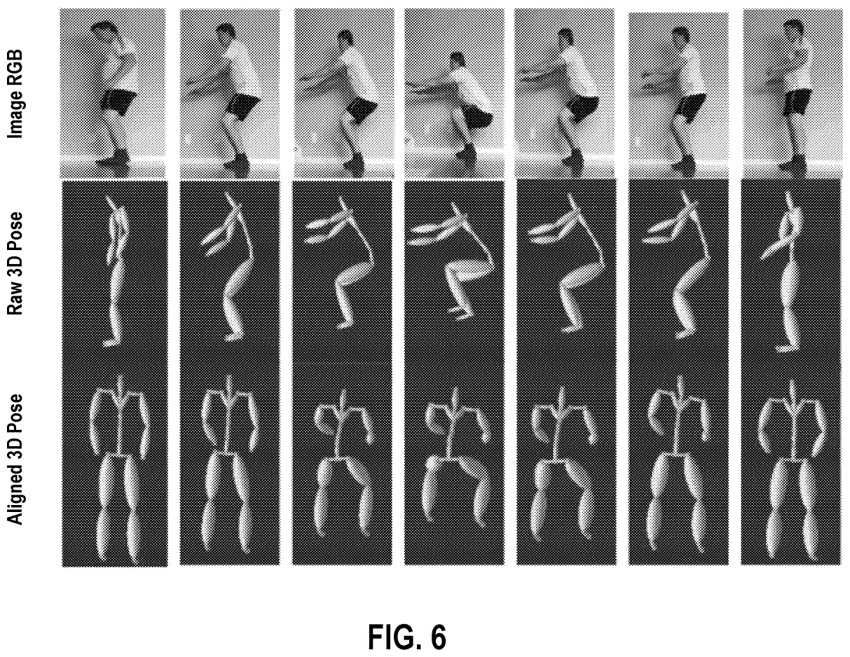

The assessment module 316 can monitor ongoing movement of the user as she completes physical activities as part of a session. While the processing module 314 may be responsible for processing data streamed to the pose monitoring platform 312 (e.g., by the image sensor 310), the assessment module 316 may be responsible for determining whether the user is moving as would be expected when completing a physical activity. As an example, assume that the image sensor 310 is positioned in front of a user. During a session, the user may be instructed to perform an exercise such as a side plank in which the hips are lifted away from the ground. In such a scenario, the assessment module 316 can examine image data generated by the image sensor 310 to determine whether the thorax and lumbar regions of the user's body are moving—either in terms of three-dimensional (3D) space or with respect to one another—as would be expected given the exercise. This is shown in FIG. 6. FIG. 6 includes a flow of red-green-blue (“RGB”) digital images that illustrate how the pose monitoring platform can estimate the raw pose and then forward align the raw poses. For example, image sensor 310 can capture the image RGB. The Raw 3D Pose is what the machine learning model is detecting from the image RGB. The Aligned 3D Pose is what the machine learning model is envisioning based on the data it has.

The implementation module 318 may be responsible for determining adherence to individual physical activities, sets of physical activities performed during sessions, or sets of sessions performed as part of a program. As shown in FIG. 4, the implementation module 400 includes a body pose module 402, a machine learning model 404, a programmatic definition data structure 406, a positions module 408, and a key positions data structure 410. In some embodiments, the implementation module 400 may include a subset of the modules and data structures shown in FIG. 4, or the implementation module 318 may include additional modules or data structures that are not shown in FIG. 4.

The body pose module 402 may be responsible for determining estimated poses of body parts as users perform physical activities. Body parts may include any portion of a user's body used to perform a physical activity (e.g., hands, feet, torso, etc.). A body part may refer to a single anatomical region (e.g., a hand), one anatomical region in relation to another anatomical region (e.g., a hand in relation to an elbow), or a series of anatomical regions in relation to another anatomical region (e.g., fingers of a hand). Physical activities may include movements performed for wellness, sports, dance, virtual reality experiences, augmented reality experiences, physical therapy, or any other activity that requires physical movement. Some examples of physical activities include dance moves (e.g., pliés, moonwalks, shuffles, etc.), sporting techniques (e.g., football throws, soccer kicks, tennis serves, basketball layups, yoga poses, etc.), exercises (e.g., planks, hip extensions, etc.), stretches, posture techniques (e.g., standing/sitting at a desk for healthy back and neck), and cooking techniques (e.g., chopping, kneading, dicing, etc.). In some embodiments, one user is a coach, and a second user is a user.

The body pose module 402 can obtain image data of an environment from the image sensor 310. The environment includes a user as she is performing one or more physical activities. In some embodiments, the image data may depict the user's entire body in the environment. In other embodiments, the image data may depict one or more of the user's body parts in the environment. For example, in one embodiment, the image data may depict only the hands and feet of the user. In some embodiments, the image data may depict body parts of multiple users. In some embodiments, one user is a coach, and a second user is a user. The body pose module 402 may store the image data in the key positions data structure 410 along with an indication of a time, date, or location associated with the capture of the image data.

In some embodiments, the key positions data structure 410 may be implemented on a computing device 300 where the image sensor 310 is located. In other embodiments, the key positions data structure 410 may be implemented in the server system of FIG. 2. The key positions data structure may be formatted to expedite pose analysis by the implementation module 400. For example, in some instances, the key positions data structure 410 may be tabulated by identifiers associated with the particular image sensor 310 that capture the image data, identifiers of the users depicted in or otherwise associated with the image data, and/or identifiers of a computing device 300 that transmitted the image data to the implementation module 400.

The body pose module 402 can extract one or more feature maps from the image data. In one embodiment, the body pose module 402 segments the image data into contiguous regions of pixels. Each contiguous region of pixels may be associated with a portion of the environment. In some embodiments, the body pose module 402 segments the image data based on objects shown in the image data. For example, the body pose module 402 may extract pixels representing the floor into a first region, a piece of furniture into a second region, and a user's right hand into a third region. In another embodiment, the body pose module segments the image data based on contrast between colors of and/or distance between the pixels. The body pose module may use one or more machine learning models to segment the image data or may use an algorithm. For example, pixels representing a hand may have similar coloring and be within a set distance threshold of one another compared to pixels of a green wall behind the hand. The body pose module 402 may create groups of pixels each associated with a color range (e.g., light to dark green or dark yellow to light orange). For each group, the body pose module 402 may determine a weighted average location of the pixels and remove pixels from the group that are a threshold distance away from the weighted average location. The body pose module 402 may iterate upon this grouping process until every pixel is associated with a group (e.g., a segment of the image data).

The body pose module 402 extracts a feature map for each segment of the image data. The term “feature map” may be used to refer to a vectorial representation of features in the image data. The body pose module 402 may extract feature maps by applying filters or feature detectors to each segment. For example, the body pose module 402 may apply a filter that detects skin to a segment and may receive, as output, a feature map highlighting which portions of the segment include skin. The body pose module 402 may store the segments and associated feature maps in the key positions data structure 410 or another datastore.

The body pose module 402 can apply the machine learning model 404 to each extracted feature map. The machine learning model 404 may include a neural network. The neural network may include a series of convolutional layers and a series of connected layers of decreasing size, and the last layer of the machine learning model 404 may be a sigmoid activation function. The machine learning model 404 can include a plurality of parallel branches that are configured to together estimate poses of body parts based on the feature maps. A first branch of the machine learning model 404 could be configured to determine a likelihood that the portion of the environment associated with the segment includes a body part, while a second branch of the machine learning model 404 could be configured to determine an estimated pose of the body part in the portion of the environment associated with the segment. In some embodiments, the body pose module 402 may employ an additional or alternative machine-learning or artificial intelligence framework to the machine learning model 404 to estimate poses of body parts.

In some embodiments, the machine learning model 404 may include additional or alternative branches that the body pose module 402 employs together to determine a pose of a body part. For example, in some embodiments, the machine learning model 404 includes a set of branches for each possible body part that may be included in the segment. For example, the machine learning model 404 may include a set of hand branches that determine a likelihood that the segment includes a hand and estimated poses of hands in the segment. The neural network may similarly include a set of branches that detect right legs in the segment and determine poses of the right legs in the segment and another set of branches that detects and determines poses of left legs in the segment. Further, the machine learning model 404 may include branches for other anatomical regions (e.g., elbows, fingers, neck, torso, upper body, hip to toes, chest and above, etc.) and/or sides of a user's body (e.g., left, right, front, back, top, bottom).

The body pose module 402 can compare the likelihood determined by the first branch of the neural network to a threshold value. The higher the likelihood, the more likely the feature map includes a body part associated with the first branch of the neural network. In some embodiments, if the body pose module 402 determines that the likelihood is greater than the threshold value, the body pose module 402 stores an indication that the body part in the segment is in the estimated pose determined by the second branch of the machine learning model 404. In embodiments where the machine learning model 404 includes a set of branches, each corresponding to a different body part (e.g., each body part of the body or a subset of body parts related to a specific portion of the body, such as the torso, lower body, etc.), the body pose module 402 compares the likelihood determined by the set to a threshold related to the body part of the set. If the likelihood exceeds the threshold, the body pose module 402 stores an indication that the body part in the segment is in the estimated pose determined by the set. In some embodiments, the body pose module 402 stores the indication with the time, date, and/or location associated with the image data of the segment.

In some embodiments, for each indication, the body pose module 402 may cause the display mechanism 306 to display an indication that the user is performing the estimated pose with the body part. The body pose module 402 may do so in near real time. For example, the body pose module 402 may receive and segment image data and apply the machine learning model 404 to determine a pose of a body part as the user is performing the pose in real time. After performing such processing, the body pose module 402 may cause the display mechanism 306 to display the indication, allowing the user to move her body parts if she is aiming for a different pose. In some embodiments, the body pose module 402 may send indications to the GUI module 320 for display via the display mechanism 306 rather than directly causing the display mechanism 306 to display indications or other information.

In some embodiments, for each indication, the body pose module 402 determines an improper position. For instance, the body pose module 402 may access the programmatic definition data structure 406 and key positions data structure 410 for the proper skeletal positions required to complete an estimated pose. The programmatic definition data structure 406 can store an attribute set. The attribute set includes a type identifier corresponding to the type of physical activity being performed, the duration over which the user may perform the physical activity, and the minimum repetition count the user can perform the physical activity for the user to receive physical benefits of the activity. In some embodiments, the programmatic definition data structure 406 can store common improper positions from analyzing multiple videos documenting either the same individual or many different individuals performing the same activity with improper form. The programmatic definition data structure 406 can additionally store a repetition count, a total duration of the performance, a duration until the improper skeletal positions, and/or an intensity level associated with the activity. In another embodiment, the body pose module 402 can determine a key skeletal position was missed while performing the physical activity. As a result, body pose module 402 can identify in which portion of performing the physical activity the patient displayed improper form. For example, the patient may fall down while performing the physical activity. Machine learning model 404 can determine, based on an automated analysis between the user's video stream and the patient's video stream, whether an improper preceding skeletal position or an improper succeeding skeletal position contributed to the patient's fall.

The body pose module 402 may cause the display mechanism 306 to display an indication of the physical activity to the user. In further embodiments, the body pose module 402 may access instructions for how the user could improve her technique (e.g., to achieve a therapeutic goal) for the physical activity based on the pose from the key positions data structure 410 and cause the display mechanism 306 to display the instructions to the user. For example, if the body pose module 402 determines that, while kickboxing, the user is posing her hand in a fist with her thumb enclosed by her fingers, the body pose module 402 may cause the display mechanism 306 to display instructions for the user to move her thumb to rest on the outside of her fingers.

In some embodiments, the body pose module 402 can determine whether a physical activity was successfully completed by the user based on estimated body poses and notify the user of her performance. For example, if an estimated body pose does not match the physical activity that a user is supposed to be doing (e.g., determined based on user data), then the body pose module 402 may prevent further progression through a session hosted by the pose monitoring platform 202 until the physical activity is determined to have been performed with one or more certain poses. In another example, the body pose module 402 may update the session based on the estimated body pose to further teach the user how to perform the body pose if the user has not matched a pattern representative of a first athletic activity. The body pose module may also update the session to focus on a second activity upon determining that the body pose does match the pattern.

Positions module 408 can train a first branch (or a first set of branches that determine likelihoods, in some embodiments) of the machine learning model 404 to determine whether image data contains body parts. The positions module 408 may obtain a set of digital images from the pose monitoring platform 202 or from a computing device connected to the pose monitoring platform 202. The positions module 408 can determine, based on locations in the set of digital images, spatial positions of one or more body parts in each of the set of digital images. In one embodiment, the positions module 408 may use an object detection model (also called an “object detector”), object recognition model (also called an “object recognizer”), or another computer vision technique to determine spatial positions of body parts. For each body part detected in the set of images, the positions module 408 can place a bounding box around the body part in each image. The positions module 408 can then iteratively displace the bounding box within the image until the bounding box no longer surrounds spatial positions associated with the body part. For each displaced instance of the bounding box, the positions module 408 can add the portion of the image associated with (e.g., enclosed by) the bounding box to a first set of training data stored in a training data structure. The positions module 408 can then train the first branch (or the first set of branches) on the first set of training data.

In some embodiments, the positions module 408 causes a display mechanism 306 of a computing device 300 associated with an external operator to display each digital image in the set. The positions module 408 may receive interactions made by the operator via a GUI of the display mechanism 306, where one or more of the interactions indicate placement of bounding boxes around body parts in the digital images and include labels for the bounding boxes with poses of an included body part. The positions module 408 can add the portion of the image associated with each bounding box to a second set of training data in the training data structure. The positions module 408 can then train the second branch of the machine learning model 404 on the second set of training data. In embodiments where the neural network includes a set of branches for each body part, the positions module 408 can train the branches configured to estimate a pose of the body part on the second set of training data.

The positions module 408 trains the neural network on the training data. In some embodiments, the positions module 408 may retrain the machine learning model 404 each time new images are added to the training data. In other embodiments, the positions module 408 may retrain the machine learning model 404 in response to a determination that at least a predetermined number of new images have been added to the training data. In further embodiments, the positions module 408 may separate the training data based on the body part shown in each bounding box and train branches of the machine learning model 404 on training data corresponding to a particular body part (e.g., the branch trained for recognizing the pose of a foot is trained on images of feet).

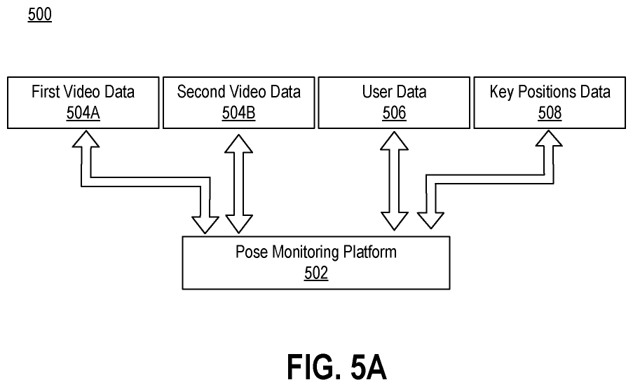

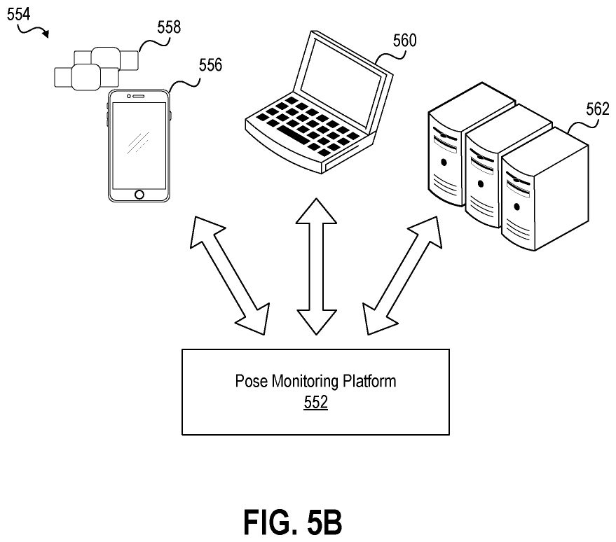

FIG. 5A depicts an example of a communication environment 500 that includes a pose monitoring platform 502 configured to receive several types of data. Here, for example, the pose monitoring platform 502 receives first video data 504A that is representative of one or more pre-recorded videos available via the YouTube video sharing platform, Facebook platform, Instagram platform, X platform, TikTok platform, or the like, second video data 504B that is representative of one or more live video streams from a coach, user data 506 that is representative of information regarding the user's posture, and key positions data 508 that is data related to the correct posture positions derived from either first video data 504A or second video data 504B. In another embodiment, the first video data 504A can refer to a video that includes proper posture, and the second video data 504B can refer to a video that includes improper posture. For example, the coach can demonstrate proper posture in the first video and improper posture for the second video. Those skilled in the art will recognize that these types of data have been selected for the purpose of illustration. Other types of data, such as community data (e.g., information regarding adherence of cohorts of users), could also be obtained by the pose monitoring platform 502.

These data may be obtained from multiple sources. For example, the key positions data 508 may be obtained from a network-accessible server system managed by a digital service that is responsible for enrolling and then engaging users in programs. The digital service may be responsible for defining the series of physical activities to be performed during sessions based on input provided by coaches. As another example, key positions data 508 may be obtained from pre-recorded videos available via the YouTube video sharing platform, Facebook platform, Instagram platform, X platform, TikTok platform, etc. The user data 506 may be obtained from various computing devices. For instance, some user data 506 may be obtained directly from users (e.g., who input such data during a registration procedure or during a session), while other user data 506 may be obtained directly from coaches who are performing the physical activities. Additionally or alternatively, user data 506 could be obtained from another computer program that is executing on, or accessible to, the computing device on which the pose monitoring platform 502 resides. For example, the pose monitoring platform 502 may retrieve user data 506 from a computer program that is associated with a healthcare system through which the user receives treatment. As another example, the pose monitoring platform 502 may retrieve user data 506 from a computer program that establishes, tracks, or monitors the health of the user (e.g., by measuring steps taken, calories consumed, or heart rate).

FIG. 5B depicts another example of a communication environment 550 that includes a pose monitoring platform 552 configured to obtain data from one or more sources. Here, the pose monitoring platform 552 may obtain data from a physical therapy system 554 comprised of a tablet computer 556 and one or more sensor units 558 (such as image sensors), personal computer 560, or network-accessible server system 562 (collectively referred to as the “networked devices”). For example, the pose monitoring platform 552 may obtain data regarding movement of a user during a session from the physical therapy system 554 and other data (e.g., therapy regimen information, models of exercise-induced movements, feedback from coaches, and processing operations) from the personal computer 560 or network-accessible server system 562.

The networked devices can be connected to the pose monitoring platform 552 via one or more networks. These networks can include PANs, LANs, WANs, MANs, cellular networks, the Internet, etc. Additionally or alternatively, the networked devices may communicate with one another over a short-range wireless connectivity technology. For example, if the pose monitoring platform 552 resides on the tablet computer 556, data may be obtained from the sensor units over a Bluetooth communication channel, while data may be obtained from the network-accessible server system 562 over the Internet via a Wi-Fi communication channel.

Embodiments of the communication environment 550 may include a subset of the networked devices. For example, some embodiments of the communication environment 550 include a pose monitoring platform 552 that obtains data from the physical therapy system 554 (and, more specifically, from the sensor units 558) in real time as physical activities are performed during a session and additional data from the network-accessible server system for pose monitoring platform 552. This additional data may be obtained periodically (e.g., on a daily or weekly basis or when a session is initiated).

### Pose Estimation Process

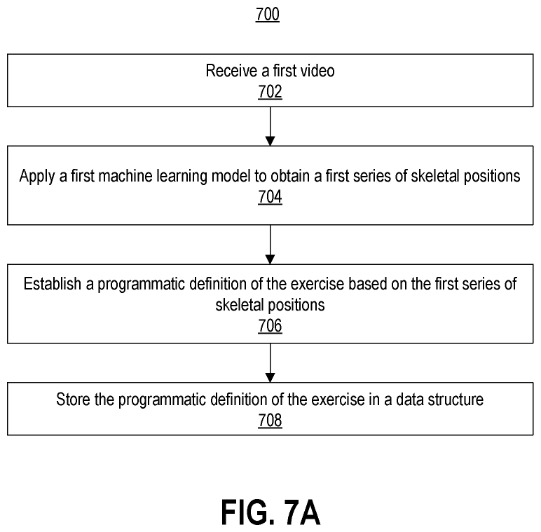

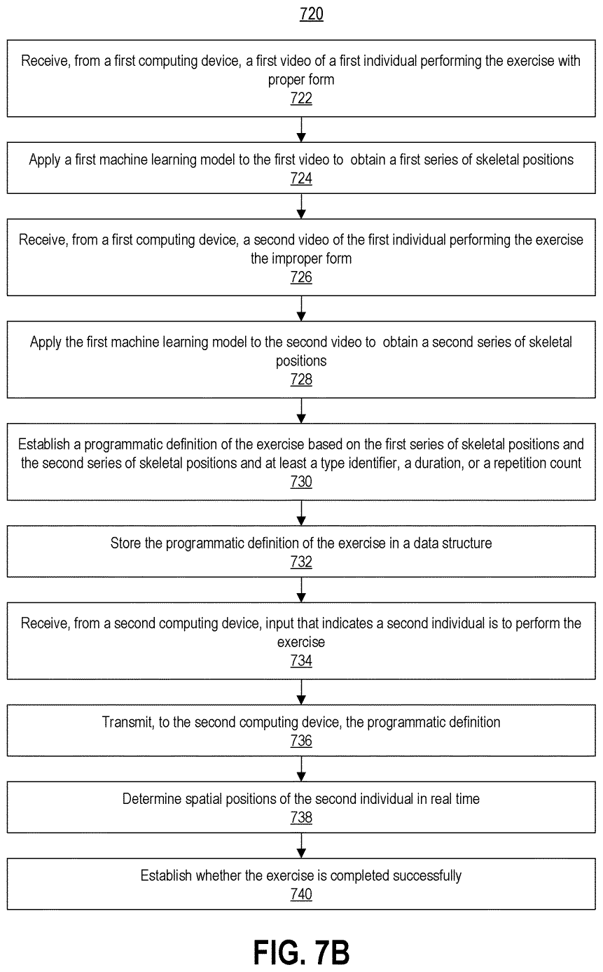

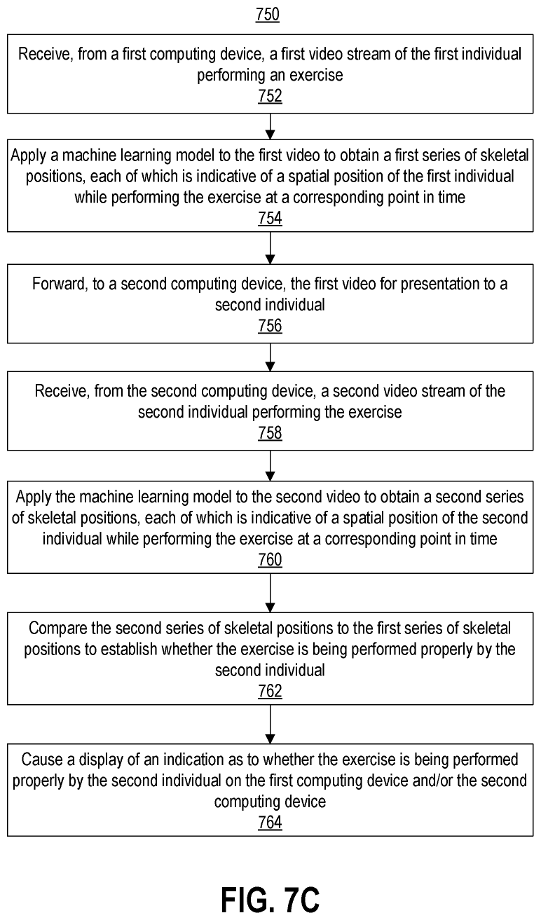

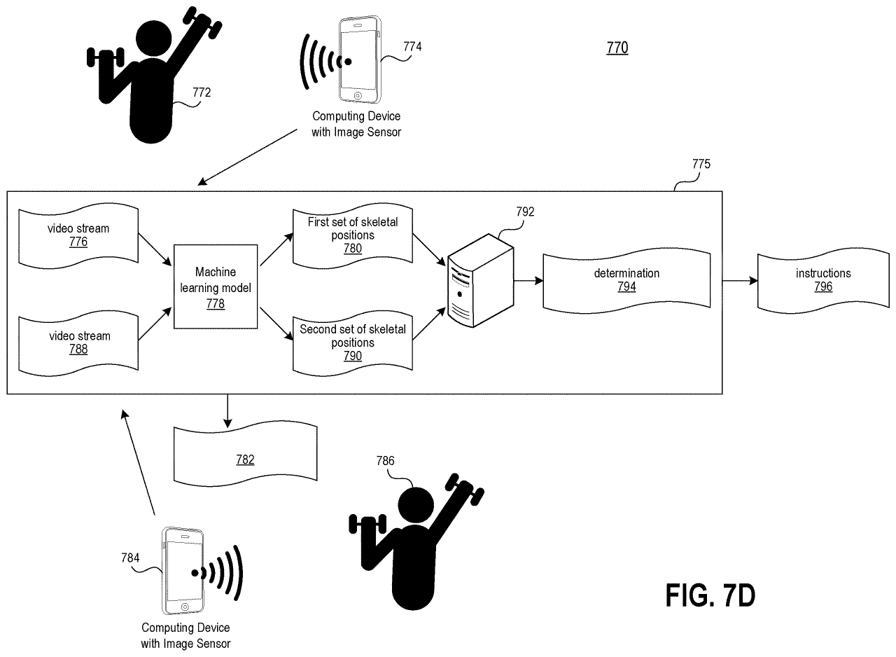

FIG. 7A depicts a flow diagram of a process 700 for generating a programmatic definition of a physical activity to be mimicked that includes at least one improper skeletal position. Initially, the body pose module 402 can receive a first video that is generated by the image sensor 310 (step 702). The body pose module 402 may obtain the first video in response to the pose monitoring platform 312 receiving input (e.g., provided via the display mechanism 306 or another control component such as a hand-held pointing device or keyboard) that is indicative of a selection of the first video or information associated with the first video. For example, a user may be permitted to browse videos (e.g., available via the YouTube video sharing platform, Facebook platform, Instagram platform, X platform, TikTok platform, etc.) and then select the first video. As another example, a user may be permitted to provide information related to the first video, such as a hyperlink to a website through which the first video is accessible or a hyperlink to a social media post through which the first video is accessible, and the pose monitoring platform 312 may retrieve the first video based on the information.

The body pose module 402 can then apply a first machine learning model to the first video to obtain a first series of skeletal positions (step 704). As discussed above, the first machine learning model may be designed and trained to produce, as output, a separate skeletal position for each frame of the first video. As such, the number of skeletal positions included in the first series may depend on the length of the first video. Generally, the first machine learning model is applied to the first video on a per-frame basis. However, in some embodiments, the first machine learning model may be applied to every other frame, every third frame, etc. This may be done to lessen consumption of computational resources, particularly if the process 700 is to be performed in near real time (e.g., where the user selects the first video with the intent to immediately mimic movement of the person captured therein).

The positions module 408 can then establish a programmatic definition of the physical activity based on the first series of skeletal positions (step 706). At a high level, the programmatic definition may be a representation of the first series of skeletal positions—or representations or derivations of the first series of skeletal positions—in temporal order that allow the pose monitoring platform 312 to understand how to complete a physical activity from a programmatic perspective. The positions module 408 can store the programmatic definition of the physical activity in a data structure in the programmatic definition data structure 406 (step 708).

FIG. 7B depicts a flow diagram of a process 720 for generating a programmatic definition of a physical activity. Here, the physical activity is an exercise, though those skilled in the art will recognize that the process 720 may be similarly applicable to other types of physical activities as discussed above. Initially, processing module 314 can receive, from a first computing device, a first video of a first individual performing the exercise with proper form (step 722). For example, the pose monitoring platform 312 may receive input from an image sensor such as image sensor 310A and/or image sensor 310B. The input may include a video showcasing a coach performing the exercise with proper form.

Assessment module 316 can apply a first machine learning model to the first video to obtain a first series of skeletal positions (step 724). As discussed above, the assessment module 316 can create, based on a digital image generated by the image sensor 310A or image sensor 310B, a first series of skeletal positions that specifies a series of spatial positions of each major anatomical region. For example, the assessment module 316 can apply a machine learning model such as a pose estimator to the digital image to produce the skeletal position. The pose estimator is applied to the first video on a per-frame basis. Therefore, the assessment module 316 produces a series of skeletal positions.

The processing module 314 can receive, from a first computing device, a second video of the first individual performing the exercise in the improper form (step 726). For example, the pose monitoring platform 312 may receive new input from image sensor 310A and/or image sensor 310B. The input may include a different video where the coach decides to perform the same exercise with improper form. For instance, the coach may perform the same exercise with improper knee placement.

The assessment module 316 can apply the first machine learning model to the second video to obtain a second series of skeletal positions (step 728). For example, the assessment module 316 utilizes the pose estimator to produce another series of skeletal positions. The implementation module 318 can establish a programmatic definition of the exercise based on the first series of skeletal positions and the second series of skeletal positions and at least a type identifier, a duration, or a repetition count (step 730). The programmatic definition can refer to the temporal order of the first series of skeletal positions that allow pose monitoring platform 312 to recognize the exercise a user is performing. Pose monitoring platform 312 can also recognize when the user is performing the exercise inaccurately based on the second series of skeletal positions by the positions module 408 determining a difference between the first series of skeletal positions and the second series of skeletal positions. In addition to that, pose monitoring platform 312 may receive input via display mechanism 306. The input may include a type identifier, a duration, and/or a repetition count for the exercise. The implementation module 318 can store the programmatic definition of the exercise in a data structure (step 732). For example, the positions module 408 can store the programmatic definition of the exercise in programmatic definition data structure 406.

The processing module 314 can receive, from a second computing device, input that indicates a second individual is to perform the exercise (step 734). For example, the processing module 314 may receive a request from a user device associated with a patient (e.g., a smartphone) to start an exercise session. In another example, pose monitoring platform 312 can receive a video stream from the user device.

The processing module 314 can transmit, to the second computing device, the programmatic definition (step 736). In response to receiving input that the patient is starting an exercise session, pose monitoring platform 312 identifies the exercise the patient is about to perform and transmits the associated programmatic definition from programmatic definition data structure 406. The implementation module 320 can determine the spatial positions of the second individual in real time (step 738). In one example, the smartphone may store a version of machine learning model 404. The body pose module 402 can apply machine learning model 404 to the received video data. However, the machine learning model 404 may be applied to every other frame, every third frame, etc. This may be done to lessen consumption of computational resources so the determination of spatial positions is performed in near real time.

The implementation module 320 can establish whether the exercise is completed successfully (step 740). For example, the body pose module 402 may access the programmatic definition data structure 406 and key positions data structure 410 for the proper skeletal positions required to complete an estimated pose. Based on the stored type identifier, duration, and/or repetition, pose monitoring platform 312 can determine how accurate the performance was. For instance, if the patient only completed 15 out of 20 sit-ups, the accuracy rate is 75 percent. FIG. 7C depicts a flow diagram of a process 750 for facilitating real-time engagement during a performance of a physical activity. Again, the process 750 has been described in the context of an exercise, though those skilled in the art will recognize that the process 750 may be similarly applicable to other types of physical activities as discussed above. Initially, the processing module 314 can receive, from a first computing device, a first video stream of the first individual performing an exercise (step 752). For example, pose monitoring platform 312 can receive, from a coach, a video stream from their user device. The video stream captures the coach performing an exercise in real time.

The implementation module 318 can apply a machine learning model to the first video to obtain a first series of skeletal positions, each of which is indicative of a spatial position of the first individual while performing the exercise at a corresponding point in time (step 754). As the coach continues to video stream live, the implementation module 318 can apply a machine learning model to extract a series of skeletal positions. As discussed above, the machine learning model may be designed and trained to produce, as output, a separate skeletal position for each frame of the live video. Generally, the machine learning model is applied to the first video on a per-frame basis. On top of that, pose monitoring platform 312 monitors the time in between each skeletal position and the order in which the positions should be performed. However, in some embodiments, the machine learning model may be applied to every other frame, every third frame, etc. This may be done to lessen consumption of computational resources, particularly if the process 750 is to be performed in near real time (e.g., where the users are performing in a live class).

The processing module 314 can forward, to a second computing device, the first video for presentation to a second individual (step 756). For example, in response to a second user (e.g., a participant) indicating they want to participate in this live class, pose monitoring platform 312 sends the live video feed to a user device associated with the second user, such as a smartphone or laptop.

The processing module 314 can receive, from the second computing device, a second video stream of the second individual performing the exercise (step 758). For example, pose monitoring platform 312 can receive, from the participant, a video stream from their user device. The video stream captures the participant mimicking the coach performing an exercise in real time.

The implementation module 318 can apply the machine learning model to the second video to obtain a second series of skeletal positions, each of which is indicative of a spatial position of the second individual while performing the exercise at a corresponding point in time (step 760). As the live class continues, the implementation module 318 can apply the machine learning model to the second live stream of the participant. Again, the machine learning model can output a separate skeletal position for each frame of the video stream. For example, the participant may be engaging in jumping jacks. The machine learning model can determine the positions of key joints by identifying a predetermined number of joints (e.g., left and right wrist, left and right elbow, left and right shoulder, left and right hip, left and right knee, left and right ankle, or any combination thereof). In another embodiment, the machine learning model is designed and trained to identify all joints that are visible in the digital image provided as input. Therefore, the machine learning model can track the locations of participant's joints as time goes on to determine a second series of skeletal positions.

The implementation module 318 can compare the second series of skeletal positions to the first series of skeletal positions to establish whether the exercise is being performed properly by the second individual (step 762). As discussed above, the implementation module 318 monitors the participant's performance in real time and applies the machine learning model to the video feed received from the participant's device and the video feed from the coach's device. Pose monitoring platform 312 can compare the skeletal positions of each user for the same temporal point in the session. By doing so, the system can determine whether the locations of the users' joints are aligned with each other. The implementation module 318 can cause a display of an indication as to whether the exercise is being performed properly by the second individual on the first computing device and/or the second computing device (step 764). The implementation module 318 may be responsible for determining appropriate feedback for the user based on the outputs produced after applying the machine learning model to the participant's performance. Specifically, the implementation module 318 may determine an appropriate personalized recommendation for the user based on her current position and a determination as to how her current position compares to the skeletal position of the user that is associated with the physical activity that she has been instructed to perform. Pose monitoring platform 312 can display the feedback on both the coach's device and the participant's device to allow the coach the ability to track the progress of the participant over time.

FIG. 7D illustrates an ecosystem of a process for generating a programmatic definition. Computing device 775 can receive, from a first computing device 774, a first video stream 776 of a first individual 772 performing an exercise. In some embodiments, computing device 775 can be the same computing device as computing device 204 or computing device 300. For example, the first individual can be an instructor for a live class. Therefore, computing device 775 can receive, from computing device 774 (e.g., a smartphone), a live stream (e.g., video stream 776) of the instructor performing an exercise routine.

In one embodiment, computing device 775 can send the first video stream 776 to computing device 775. Then, computing device 775 can apply a machine learning model 778 (e.g., a pose estimator) to the first video stream 776 so as to obtain a first series of skeletal positions 780, each of which is indicative of a spatial position of the first individual 772 while performing the exercise at a corresponding point in time. Computing device 775 can forward, to a second computing device 784, the first video 782 for presentation to a second individual 786. For example, computing device 775 can receive a notification indicating a participant will be joining the live class. Therefore, computing device 775 can forward the live stream of the instructor to computing device 784 (e.g., a smartphone). In another embodiment, computing device 774 can process first video stream 776 by applying a machine learning model to the video data. Afterwards, computing device 774 can transmit the skeletal positions 780 to the participant's computing device 784.

Computing device 775 can receive, from the second computing device 784, a second video stream 788 of the second individual 786 performing the exercise. For example, computing device 775 can receive from the smartphone associated with the participant (e.g., computing device 784) a live stream (e.g., video stream 788) of the participant performing the exercise routine. Computing device 775 can apply the machine learning model 778 to the second video stream 788 so as to obtain a second series of skeletal positions 790, each of which is indicative of a spatial position of the second individual 786 while performing the exercise at a corresponding point in time. Computing device 775 can compare the second series of skeletal positions 790 to the first series of skeletal positions 780 so as to establish whether the exercise is being performed properly by the second individual, such as determination 794. In particular, server 792 can compare the first set of skeletal positions 780 and the second set of skeletal positions 790. Server 792 can output determination 794. In some embodiments, server 792 can be a part of the server system 210 of FIG. 2. Finally, computing device 775 can transmit instructions 796 to cause a display of an indication as to whether the exercise is being performed properly by the second individual on the first computing device and/or the second computing device.

As an illustrative example, assume that the first individual 772 is an instructor for an exercise session—to be streamed live or recorded and then played back—while the second individual 786 is a participant in the exercise session. In some embodiments, the first video stream 776 that captures the first individual 772 performing a series of exercises is processed by her own computing device 774—for example, by applying the machine learning model 778 thereto—and then the first set of skeletal positions 780 is transmitted to a computer server 792. In other embodiments, the first video stream 776 is transmitted to the computer server 792, which may apply the machine learning model 778 to produce the first set of skeletal positions 780. Similarly, the second video stream 788 that captures the second individual 786 performing the series of exercises, mirroring the first individual 772, may be processed by her own computing device 784—for example, by applying the machine learning model 778 thereto—and then the second set of skeletal positions 790 may be transmitted to the computer server 792. Alternatively, the second video stream 788 may be transmitted to the computer server 792, which may apply the machine learning model 778 to produce the second set of skeletal positions 790. As discussed above, the computer server 792 may compare the first set of skeletal positions 780 and second set of skeletal positions 790 in order to make a determination 794 as to whether the second individual 786 is properly mirroring the performances of the first individual 772. Note that, in some embodiments, the computer server 792 may instead transmit the first set of skeletal positions 780 to the computing device 784 associated with the second individual 786, and that computing device 784 may compare the first set of skeletal positions 780 to the second set of skeletal positions 790 that is produced by applying the machine learning model 778 to the second video stream 788. Such an approach may be beneficial in embodiments where the computing device 784 has sufficient computational capabilities and resources to apply the machine learning model 778 in near real time but has poor network connectivity. Whether the first set of skeletal positions 780 and second set of skeletal positions 790 are compared on the computer server 792 or computing device 784 associated with the second individual 786 may depend on, for example, the computational capabilities and resources of the computing device 784, network connectivity strength of the computing device 784, etc.

### Processing System

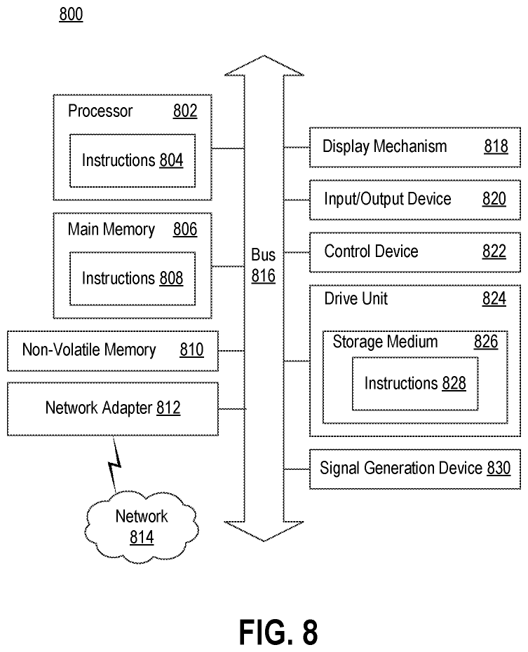

FIG. 8 is a block diagram illustrating an example of a processing system 800 in which at least some operations described herein can be implemented. For example, components of the processing system 800 may be hosted on a computing device that includes a pose monitoring platform (e.g., pose monitoring platform 102 of FIG. 1, pose monitoring platform 202 of FIG. 2, or pose monitoring platform 312 of FIG. 3).

The processing system 800 may include a processor 802, main memory 806, non-volatile memory 810, network adapter 812, video display 818, input/output device 820, control device 822 (e.g., a keyboard or pointing device), drive unit 824 including a storage medium 826, and signal generation device 830 that are communicatively connected to a bus 816. The bus 816 is illustrated as an abstraction that represents one or more physical buses or point-to-point connections that are connected by appropriate bridges, adapters, or controllers. The bus 816, therefore, can include a system bus, a Peripheral Component Interconnect (“PCI”) bus or PCI-Express bus, a HyperTransport or industry standard architecture (“ISA”) bus, a small computer system interface (“SCSI”) bus, a universal serial bus (“USB”), inter-integrated circuit (“I2C”) bus, or an Institute of Electrical and Electronics Engineers (“IEEE”) standard 1394 bus (also referred to as “Firewire”).

While the main memory 806, non-volatile memory 810, and storage medium 826 are shown to be a single medium, the terms “machine-readable medium” and “storage medium” should be taken to include a single medium or multiple media (e.g., a centralized/distributed database and/or associated caches and servers) that store one or more sets of instructions 828. The terms “machine-readable medium” and “storage medium” shall also be taken to include any medium that is capable of storing, encoding, or carrying a set of instructions for execution by the processing system 800.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in a computing device. When read and executed by the processors 802, the instruction(s) cause the processing system 800 to perform operations to execute elements involving the various aspects of the present disclosure.

Further examples of machine-and computer-readable media include recordable-type media, such as volatile memory and non-volatile memory 810, removable disks, hard disk drives, and optical disks (e.g., Compact Disk Read-Only Memory (“CD-ROMS”) and Digital Versatile Disks (“DVDs”)), and transmission-type media, such as digital and analog communication links.

The network adapter 812 enables the processing system 800 to mediate data in a network 814 with an entity that is external to the processing system 800 through any communication protocol supported by the processing system 800 and the external entity. The network adapter 812 can include a network adapter card, a wireless network interface card, a router, an access point, a wireless router, a switch, a multilayer switch, a protocol converter, a gateway, a bridge, a bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification unless those terms are explicitly defined herein. Accordingly, the actual scope of the technology encompasses not only the disclosed embodiments but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description but rather by any claims that issue on an application based hereon. Accordingly, the disclosure of various embodiments is intended to be illustrative, but not limiting, of the scope of the technology as set forth in the following claims.

What is claimed is:

1. A method for generating a programmatic definition of an activity to be mimicked that includes at least one improper skeletal position, the method comprising:
receiving, from a first computing device associated with a first individual, input that includes a video that documents a first performance of an activity;
obtaining a copy of the video;
applying a machine learning model, the copy of the video, so as to obtain a first series of skeletal positions, each of which is indicative of a spatial position of a human body at a corresponding point in time during the first performance of the activity;
identifying an improper skeletal position for the activity in the first series of skeletal positions;
establishing a programmatic definition for the activity that includes (i) the improper skeletal position and (ii) a second series of skeletal positions that is known to correspond to a second performance of the activity with proper form; and
transmitting, to a second computing device associated with a second individual, the programmatic definition for implementation by a computer program that is programmed to:
determine spatial positions of the second individual in real time during a third performance of the activity, and
establish whether the activity is performed with proper form based on a continual comparison of the spatial positions to the programmatic definition.

2. The method of claim 1, wherein said identifying comprises identifying based on a second input received from the first computing device, wherein the second input comprises a video or an additional series of skeletal positions that includes an improper position.

3. The method of claim 1, further comprising performing an automated analysis by comparing the second series of skeletal positions against the first series of skeletal positions.

4. The method of claim 1, wherein the improper skeletal position corresponds to a portion of the activity.

5. The method of claim 4, wherein the portion of the activity could be identified based on a duration of time, a preceding skeletal position, a succeeding skeletal position, or any combination thereof.

6. The method of claim 1, wherein the video is one of multiple videos that is identified in the input, and wherein each video of the multiple videos documents a different individual performing the activity with improper form.

7. The method of claim 1, wherein the video is one of multiple videos that is identified in the input, and wherein each video of the multiple videos documents a same individual performing the activity with improper form.

8. The method of claim 1, wherein said identifying comprises:
identifying additional context for the improper skeletal position based on an analysis of the copy of the video and/or the first series of skeletal positions.

9. The method of claim 8, wherein the additional context comprises a repetition count, a total duration of the first performance, a duration until the improper skeletal position, an intensity level, or any combination thereof.

10. The method of claim 1, wherein said establishing comprises establishing a common improper skeletal position associated with the activity based on analysis of multiple series of skeletal positions that are known to be associated with performances of the activity with improper form, and wherein the first series of skeletal positions is one of the multiple series of skeletal positions.

11. A computing device comprising:
an image sensor that is configured to generate a video of an individual completing a first performance of an activity;
a processor; and
a memory with instructions stored therein that, when executed by the processor, cause the computing device to:
receive input indicative of a request to document the first performance of the activity,
cause the image sensor to generate the video,
apply, to the video, a machine learning model that outputs a first series of skeletal positions, each of which is indicative of a spatial position of the individual while completing the first performance of the activity at corresponding points in time,
compare the first series of skeletal positions to a programmatic definition that is associated with the activity,
wherein the programmatic definition includes (i) a second series of skeletal positions that is known to correspond to a second performance of the activity with proper form and (ii) an improper skeletal position learned through analysis of a third performance of the activity with improper form, and
notify the individual whether the first performance is completed with proper form.

12. The computing device of claim 11, wherein continual comparison further comprises calculating a similarity score using an analysis algorithm to determine a percentage metric measuring an accuracy of the individual performing the activity.

13. The computing device of claim 11, further comprising:
generating a point system, wherein the individual receives a point for every completed exercise, and wherein the individual receives multiple points for a high similarity score;
displaying, to the individual, a number of points received after the activity is completed; and
in response to determining the individual can perform the activity with a higher similarity score, notifying the individual of an opportunity to perform the activity a second time for double the number of points.

14. A method for generating a programmatic definition of an exercise, the method comprising:
receiving, from a first computing device, a first video of a first individual performing the exercise with proper form;
applying a first machine learning model to the first video, so as to obtain a first series of skeletal positions, each of which is indicative of a spatial position of the first individual while performing the exercise with proper form at a corresponding point in time;
receiving, from the first computing device, a second video of the first individual performing the exercise with improper form;
applying the first machine learning model to the second video, so as to obtain a second series of skeletal positions, each of which is indicative of a spatial position of the first individual while performing the exercise with improper form at a corresponding point in time;
establishing the programmatic definition of the exercise by creating an attribute set that includes the first series of skeletal positions, the second series of skeletal positions, and at least one of:
(i) a type identifier corresponding to a type of the exercise,
(ii) a duration corresponding to an interval of time over which to perform the exercise, and
(iii) a repetition count corresponding to a minimum number of repetitions to perform the exercise;
storing the programmatic definition of the exercise in a data structure;
receiving, from a second computing device, input that indicates a second individual is to perform the exercise; and
transmitting, to the second computing device, the programmatic definition for implementation by a computer program that is programmed to:
determine spatial positions of the second individual in real time during a performance of the exercise, and
establish whether the exercise is completed successfully based on a continual comparison of the spatial positions to the programmatic definition.

15. The method of claim 14, wherein said storing comprises storing associated improper skeletal positions with the programmatic definition.

16. The method of claim 14, further comprising:
in response to establishing the exercise is not completed successfully, initiating a communication session between the second individual and a third individual that is responsible for monitoring exercises performed by the second individual.

17. A non-transitory medium with instructions stored thereon that, when executed by a processor of a computing device, cause the computing device to perform operations comprising:
receiving, from a first computing device, video of a first individual performing an exercise;
identifying, based on an analysis of the video, a series of skeletal positions, each of which is indicative of a spatial position of the first individual while performing the exercise at a corresponding point in time,
wherein said identifying involves establishing whether each skeletal position is classified as a proper skeletal position or an improper skeletal position;
establishing a programmatic definition of the exercise by creating an attribute set that includes all skeletal positions in the series of skeletal positions that are classified as proper skeletal positions;
storing the programmatic definition of the exercise in a data structure;
receiving, from a second computing device, input that indicates a second individual is to perform the exercise; and
transmitting, to the second computing device, the programmatic definition to:
establish whether the exercise is completed successfully based on a continual comparison of spatial positions of the second individual during a performance of the exercise to the programmatic definition.

18. The non-transitory medium of claim 17, wherein the attribute set further comprises:
(i) a type identifier corresponding to a type of the exercise,
(ii) a duration corresponding to an interval of time over which to perform the exercise, and
(iii) a repetition count corresponding to a minimum number of repetitions to perform the exercise.

19. A non-transitory medium with instructions stored thereon that, when executed by a processor of a computing device, cause the computing device to perform operations comprising:
applying a machine learning model to a video, so as to obtain a series of skeletal positions, each of which is indicative of a spatial position of an individual while performing an exercise at a corresponding point in time;
establishing a programmatic definition of the exercise based on the series of skeletal positions; and
storing the programmatic definition of the exercise in a data structure.

20. A computing device comprising:
an image sensor;
at least one hardware processor; and
a memory with instructions stored thereon that, when executed, cause the computing device to perform actions comprising:
determining a first series of skeletal positions of an individual in real time during a performance of an exercise by applying a machine learning model to video generated by the image sensor;
comparing the first series of skeletal positions to a second series of skeletal positions included in a programmatic definition that is associated with the exercise, so as to establish whether the exercise is being performed successfully; and
in response to establishing the exercise is completed successfully, causing display of a notification to the individual,
wherein the notification includes an indication that the individual successfully completed the exercise and a performance metric that is representative of accuracy of the performance.

21. The computing device of claim 20, wherein the actions further comprise:
in response to establishing the exercise is not completed successfully, causing display of another notification to the individual,
wherein the another notification indicates which skeletal positions in the first series of skeletal positions were determined to be improper.

22. A method for facilitating real-time engagement during a performance of an activity, the method comprising:
receiving, from a first computing device, a first video stream of a first individual performing an exercise;
applying a machine learning model to the first video stream, so as to obtain a first series of skeletal positions, each of which is indicative of a spatial position of the first individual while performing the exercise at a corresponding point in time;
forwarding, to a second computing device, the first video stream for presentation to a second individual;
receiving, from the second computing device, a second video stream of the second individual performing the exercise;
applying the machine learning model to the second video stream, so as to obtain a second series of skeletal positions, each of which is indicative of a spatial position of the second individual while performing the exercise at a corresponding point in time;
comparing the second series of skeletal positions to the first series of skeletal positions, so as to establish whether the exercise is being performed properly by the second individual; and
causing a display of an indication as to whether the exercise is being performed properly by the second individual on the first computing device and/or the second computing device.

23. A computing device comprising:
an image sensor that is configured to generate a video of an individual completing a first performance of an activity;
a processor; and
a memory with instructions stored therein that, when executed by the processor, cause the computing device to:
receive a programmatic definition corresponding to the activity;
cause the image sensor to capture a user video feed, wherein the user video feed comprises a first individual performing the activity;
determine a series of skeletal positions of the first individual in real time during the activity using a machine learning model wherein the series of skeletal positions comprises a series of spatial positions performed by the first individual;
compare the skeletal positions of the first individual to the series of skeletal positions of the programmatic definition of the activity to establish whether the activity is being performed successfully;
establish whether the activity is completed successfully based on a continual comparison of the spatial positions to the programmatic definition;
display an evaluation metric, wherein the evaluation metric is based on the continual comparison; and
transmit, to a database, the continual comparison of the spatial positions to the programmatic definition and each evaluation metric.
